(19) United States
(12) Patent Application Publication
(10) Pub. No.: US 2025/0280355 A1
(43) Pub. Date: Sep. 4, 2025

(54) METHODS AND APPARATUSES TO HANDLE PLMN LIST

(71) Applicant: Samsung Electronics Co., Ltd., Gyeonggi-do (KR)

(72) Inventors: Aman AGARWAL, Bangalore (IN); Lalith KUMAR, Bangalore (IN); Kailash Kumar JHA, Bangalore (IN); Avneesh TIWARI, Bangalore (IN); Mahmoud WATFA, Bangalore (IN)

(21) Appl. No.: 18/862,845

(22) PCT Filed: May 8, 2023
(86) PCT No.: PCT/KR2023/006193

§ 371 Date: Nov. 4, 2024

(30) Foreign Application Priority Data
May 5, 2022 (IN) 202241026288
Jun. 15, 2022 (IN) 202241034390
Apr. 25, 2023 (IN) 202241026288

(51) Int. Cl. H04W 48/16; H04W 4/90; H04W 48/04; H04W 84/04

(52) U.S. Cl. CPC H04W 48/16; H04W 4/90; H04W 48/04; H04W 84/042

(57) ABSTRACT

The disclosure relates to a 5G or 6G communication system for supporting a higher data transmission rate. The present disclosure provides methods for handling a PLMN list. The method includes determining, by a UE (100), whether the UE (100) is successfully registered to the PLMN stored in the list of “PLMN not allowed to operate at the present UE location” via satellite access network (500) for emergency services or normal services. In an embodiment, the method includes not removing an entry from the list of “PLMN not allowed to operate at a present UE location” at the UE (100) upon determining that the UE (100) is successfully registered for emergency services via satellite access network (500).

### TECHNICAL FIELD

Embodiments disclosed herein relate to wireless networks, and more particularly to methods and systems to prioritize home radio access network (RAN) for getting services, and also more specifically to methods and systems for handling of public land mobile network (PLMN) list.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

FIG. 1 illustrates a scenario (S100) of a UE (100) present in a overlapping area of a home RAN (200a) and a visited RAN (V-RAN) (200b) which is a shared RAN (300), according to prior art. The shared RAN's (300) are used by multiple operators to extend operator coverage by leveraging RAN's of other network or partner network/operators. This reduces an overall network deployment cost. The shared RAN can deploy a Multi-Operator Core Network (MOCN) for network sharing between these/partner operators in which multiple Core Network (CN) nodes are connected to the same radio access and the CN nodes are operated by different operators. The shared RAN can be directly connected to the participating operator's core network (Direct Network Sharing) or the communication between the shared access NG-RAN and the participating operator's core network can be routed through the hosting operator's core network (Indirect Network Sharing). For the purpose of providing wider coverage and cost optimization for deployment of cellular services, the concept of network sharing/Shared RAN was introduced.

Shared RAN(s) are used by multiple operators to extend operator coverage by leveraging RAN's of other network or partner network/operators. This reduces the overall network deployment cost.

In network sharing, the shared access network/Shared RAN/NG-RAN is common for multiple operators which is connected to participating operator's core network via Host operator's core network (i.e. Indirect Network Sharing). The benefits arising from such shared network deployment can be multiple, including cost savings and faster deployment of 5G services.

Also, there may be cases where the Shared Access Network/Shared RAN/NG-RAN might be directly connected to the participating operators' Core Network (i.e. Direct Network Sharing without any indirect connection to host operator's core network).

In a current real world scenario, most operator deployment scenarios include own RAN's i.e., home-RAN (200a) (In an example, e.g. RAN's deployed and owned by an operator whose public land mobile network identifier/identity (PLMN ID) is being broadcasted by the RAN) as well as shared RAN's (V-RAN) (200b) belonging to other operators (for e.g.—RAN's deployed and owned by any partner operator which broadcasts the PLMN ID of the UE's (100) home operator (or the selected PLMN ID's Operator) along with the PLMN ID of the partner operator to which the RAN belongs). There might also be cases of overlapping where the home-RAN (200a) and the visited-RAN (V-RAN) service an overlap in a certain region.

In a shared region, the home RAN (200a) may broadcast or may indicate its own HPLMN/EHPLMN/Operator controlled Public land Mobile Network (OPLMN)/User controlled Public land Mobile Network (UPLMN) list (for e.g. first PLMN) or any random PLMN ID in any Access Stratum (AS) or Non-Access Stratum (NAS) signalling. The visited RAN (V-RAN) (200b) may broadcast or may indicate its own HPMLN/EHPLMN/OPLMN/UPLMN list (for e.g. second PMN (i.e., PLMN 2)) or any random PLMN ID as well as the PLMN ID or the VPLMN list of its Partner Network/Operator (for e.g. the PLMN ID for which V-RAN (200b) is providing services for the partner network (i.e., first PLMN), the PLMN ID or the VPLMN list might be the HPLMN/EHPLMN/OPLMN/UPLMN List of some other RAN nodes (for e.g. Home-RAN (200a)) in any AS or NAS signalling. The UE (100) may be connected to either of Home RAN (200a) or the V-RAN (200b) for the selected PLMN ID (for e.g. first PLMN). The UE (100) may not differentiate or prioritize between the Home RAN (200a) and the V-RAN (200b) for the selected PLMN ID (for e.g. first PLMN).

UE's Preferred PLMN List as per 23.122: The UE (100) selects and attempts registration on the PLMN/access technology combinations, if available and allowable, in all of its bands of operation in accordance with the following order:
the RPLMN;
the HPLMN (if the EHPLMN list is not present or is empty) or the highest priority EHPLMN that is available (if the EHPLMN list is present);
PLMN/access technology combinations contained in the “User Controlled PLMN Selector with Access Technology” data file in a subscriber identity module (SIM) (in priority order) excluding the previously selected PLMN/access technology combination;
   I. PLMN/access technology combinations contained in the “Operator Controlled PLMN Selector with Access Technology” data file in the SIM (in priority order) or stored in the ME (in priority order) excluding the previously selected PLMN/access technology combination;
   II. other PLMN/access technology combinations with the received high quality signal in random order excluding the previously selected PLMN/access technology combination;
UE's Preferred PLMN List as per 23.122 excluding RPLMN: The UE (100) selects and attempts registration on the PLMN/access technology combinations, if available and allowable, in all of its bands of operation in accordance with the following order:
   I. the HPLMN (if the EHPLMN list is not present or is empty) or the highest priority EHPLMN that is available (if the EHPLMN list is present);
   II. the PLMN/access technology combinations contained in the “User Controlled PLMN Selector with Access Technology” data file in the SIM (in priority order) excluding the previously selected PLMN/access technology combination;
   III. the PLMN/access technology combinations contained in the “Operator Controlled PLMN Selector with Access Technology” data file in the SIM (in priority order) or stored in the ME (in priority order) excluding the previously selected PLMN/access technology combination; and
   IV. other PLMN/access technology combinations with the received high quality signal in random order excluding the previously selected PLMN/access technology combination;
Currently, the UE (100) does not differentiate between available RAN nodes (for example—Home-RAN (200a) and V-RAN (200b)) to select and camp/register for services if the selected/preferred PLMN ID by the UE (100) is broadcasted or indicated via any AS or NAS signalling by both the RAN(s) (i.e., Home-RAN (200a) and V-RAN (200b)). There is no priority given by the UE (100) between the Home RAN (200a) or the V-RAN (200b) when the UE (100) needs to select the same PLMN (for e.g., HPLMN/EHPLMN or any higher priority PLMN or any other random PLMN) either from the Home RAN (200a) or the V-RAN (200b).

However, when the UE (100) is accessing the PLMN services through the V-RAN (200b), the UE's Home Operator may have to pay higher charges to other network service providers (for example—to the Network service provider of the V-RAN (200b)). Also, the UE (100) might get the quality of service from the V-RAN (200b) which might not be the same and may be lower than the quality/type of service that the UE (100) might get from the Home-RAN (200a).

Further, the UE (100) might not get all the services from the V-RAN (200b) which it can get from the Home-RAN (200a). Additionally, the quality of service and/or the policies or charging given by the V-RAN (200b) to the UE (100) might not be under the complete control of the Home operator and UE (100) services might be affected.

In case of disaster condition/situation, when one operator's NG-RAN fails (i.e., Home RAN (200a)) or operator's 5G core (5GC) network fails, the service interruption can be minimized by temporarily using the service provided by the RAN (V-RAN) network or by the RAN (V-RAN) network (200b) as well as the Core Network of a co-operative operator. The affected users may not be aware of the change and they may continue to obtain service from the PLMN that they have been served by before a disaster condition applies, by the same or a different RAN (V-RAN (200b)).

Once the disaster condition is over and the Home-RAN (200a) is available and is broadcasting or indicating via any AS or NAS signalling, services for the PLMN on which UE (100) is currently camped on or is currently registered to or any higher priority PLMN of the UE (100), the UE (100) may keep utilizing the services for the same PLMN from the V-RAN (200b) and the UE (100) may not register or select or camp or reselect to the Home-RAN (200a).

FIG. 2 illustrates a sequential diagram in which the UE (100) is unable to identify the Home RAN (200a) and the V-RAN (200b), according to prior art.

When the UE (100) is accessing the home network through the V-RAN (200b), then the home operator has to pay higher charges to other partner network service providers which are providing the RAN service on behalf of the home operator. Also, the V-RAN (200b) might be providing different services to the UE (100) in comparison to the Home-RAN (200a), the quality of service might be affected and it is not fully under the control of the home operator.

Currently, there is no way for the UE (100) to identify and differentiate between the Home-RAN (200a) and the V-RAN (200b) if the PLMN being searched or selected by the UE (100) is broadcasted or indicated via any AS or NAS signalling message by multiple RAN nodes(s) (for e.g. Home-RAN (200a) and V-RAN (200b)). Hence, a method needs to be proposed.

As shown in FIG. 2, consider, the priority of PLMN for the UE (100) is PLMN 2>PLMN 1. The PLMN 3 belongs to Forbidden PLMN List (FPLMN) list of the UE (100). At step 1, the RAN_A (i.e., Home RAN) broadcasts the PLMNs such as PLMN 1 and PLMN 2. At step 2, the RAN_B (i.e., visited RAN) broadcasts the PLMNs such as PLMN 2 and PLMN 3. If the UE (100) not able to identify the Home RAN (200a) and the V-RAN (200b) then, the UE (100) can camp on the RAN_A as PLMN 2 is of higher priority for the UE (100) at step 3. At step 4, the UE (100) can camp on RAN_B as the PLMN 2 is of higher priority for the UE (100).

Further, For Third Generation Partnership Project (3GPP) satellite Next Generation Radio Access Network (NG-RAN) or 3GPP satellite Evolved Universal Mobile Telecommunications System (UMTS) Terrestrial Radio Access Network (E-UTRAN) or any Satellite Access Network, the UE (100) stores a list of PLMNs which may not be allowed to operate at a certain location, termed as “PLMN not allowed to operate at the present UE location”. Each entry in the list may consists of:
a) the PLMN identity of the PLMN which sent a message including at least one of a 5G NAS Mobility Management (5GMM) or a EUTRAN Mobility Management (EMM) cause value #78 “PLMN not allowed to operate at the present UE location” via satellite Access Network (i.e., at least one of satellite NG-RAN access technology, satellite E-UTRAN access technology or any 3GPP or Non-3GPP satellite access technology;
b) the geographical location, if known by the UE, where 5GMM or EMM cause value #78 was received on satellite NG-RAN/E-UTRAN access technology; and
c) if the geographical location exists, a UE implementation specific distance value. Optionally, the UE implementation specific distance value shall not be set to a value smaller than the value indicated by the network, if any.

Before storing a new entry in the list, the UE (100) deletes any existing entry with the same PLMN identity. Upon storing a new entry, the UE (100) starts a timer instance associated with the entry with an implementation specific value that shall not be set to a value smaller than the timer value indicated by the network, if any.

The UE (100) is allowed to attempt to access the PLMN via a satellite NG-RAN/E-UTRAN access technology which is part of the list of “PLMN not allowed to operate at the present UE location” only if:
a) the current UE location is known, a geographical location is stored for the entry of the PLMN, and the distance to the current UE location is larger than a UE implementation specific value. The UE implementation specific value shall not be set to a value smaller than the value indicated by the network, if any;
b) the timer associated with the entry of the PLMN has expired; or
c) the access is for emergency services.

The list of PLMN accommodates three or more entries. When the list is full and a new entry has to be inserted, the oldest entry shall be deleted. Each entry is removed if for the entry:
a) the UE (100) successfully registers via satellite NG-RAN/E-UTRAN access technology to the PLMN stored in the entry; or
b) the timer instance associated with the entry expires.

The UE (100) may delete the entry in the list, if the current UE location is known, a geographical location is stored for the entry of the PLMN, and the distance to the current UE location is larger than a UE implementation specific value.

When the UE (100) is switched off, the UE (100) keeps the list of “PLMN not allowed to operate at the present UE location” in its non-volatile memory. The UE (100) deletes the list of “PLMN not allowed to operate at the present UE location” if a Universal Subscriber Identity Module (USIM) is removed.

When the UE (100) or a MS attempts to get emergency service for instance via an emergency registration in the PLMN via the satellite NG-RAN/E-UTRAN access technology, which has an entry in the list of “PLMN not allowed to operate at the present UE location” present or stored in the UE (100) or the MS, via the satellite NG-RAN/E-UTRAN access technology, the UE (100) or MS can get emergency services from the PLMN.

After the successful emergency registration of the UE (100) or MS on the PLMN for the emergency services via the satellite NG-RAN/E-UTRAN access technology, which is part of the list “PLMN not allowed to operate at the present UE location” present or stored in the UE, there is no further action or behaviour specified or defined in the 3GPP system for the MS or UE (100) with respect to PLMN list handling.

As an illustration, when a first PLMN (i.e. PLMN 1) & a third PLMN (i.e., PLMN 3) are in list of “PLMN not allowed to operate at the present UE location” as the UE (100) received integrity protected reject message with 5GMM/EMM cause value #78 on the first PLMN & third PLMN previously and if:
a. The UE initiates a registration/Attach procedure with registration/Attach type as emergency registration or EPS Emergency Attach on the first PLMN via satellite access network (satellite NG-RAN access or satellite E-UTRAN access or any 3GPP or Non-3GPP Satellite Access Network) for emergency services (e.g., for Emergency call).
b. The network (NW) function (for ex—an Access and Mobility Management Function (AMF) or a Mobility Management Entity (MME)) sends a RA (Registration accept) message or a Attach Accept message to the UE (100) or the MS on the first PLMN after successful emergency registration for the emergency services or for emergency bearer services.
c. As the emergency registration is successful on the first PLMN, there is no further action or behaviour is specified or defined in the 3GPP system for the MS or UE (100) with respect to the PLMN list handling.

It is desired to address the above mentioned disadvantages or other short comings or at least provide a useful alternative.

### DISCLOSURE OF INVENTION

### Technical Problem

The present invention has been made to address at least the above problems and/or disadvantages and to provide at least the advantages described below. Accordingly, an aspect of the present invention provides methods and apparatuses to handle PLMN list.

### Solution to Problem

The principal object of the embodiments herein is to disclose methods and apparatuses for handling a PLMN list.

Another object of the embodiments herein is to disclose methods and apparatuses to prioritize a home RAN for getting services.

Another object of the embodiments herein is to disclose that when the UE registers/attaches to a PLMN for emergency services/emergency bearer services via a satellite NG-RAN/satellite E-UTRAN access technology which is part of a list of “PLMN not allowed to operate at a present UE location”, the UE does not delete/remove at least one of a PLMN entry, a current geographical location, and a UE implementation specific distance value from the list even if the UE registration/attach is successful for the emergency services or emergency bearer services.

Another object of the embodiments herein is to disclose that when the UE performs successful registration/attach with a PLMN due to a normal registration i.e. NOT due to the emergency services via a satellite NG-RAN/satellite E-UTRAN access technology which is part of a list of “PLMN not allowed to operate at a present UE location”, the UE deletes at least one of the PLMN entry, the current geographical location and the UE implementation specific distance value from the list.

Another object of the embodiments herein is to disclose that when the UE is present in the overlapping area of a Home-RAN and a Visited-RAN (V-RAN), the UE prioritizes the Home-RAN over V-RAN for a selected PLMN (for ex-any of HPLMN/EHPLMN or any higher priority PLMN if available) if the same selected PLMN is broadcasted or indicated via any AS/NAS signalling by multiple RAN(s) (for ex-Home-RAN and V-RAN).

Accordingly, the embodiments herein provide methods for handling a PLMN list. The method includes storing, by a User Equipment (UE), a list of “PLMN not allowed to operate at the present UE location”. In an embodiment, the method includes registering or attaching, by the UE to a satellite access apparatus of a PLMN, stored in the list of “PLMN not allowed to operate at the present UE location” via a satellite access network. Further, the method includes determining, by the UE, whether the UE is successfully registered to the PLMN stored in the list of “PLMN not allowed to operate at the present UE location” via the satellite access network for emergency services or normal services, In an embodiment, the method includes not removing an entry from the list of “PLMN not allowed to operate at the present UE location” stored at the UE upon determining that the UE is successfully registered for the emergency services to the PLMN stored in that entry in the list of “PLMN not allowed to operate at the present UE location” via the satellite access network. In another embodiment, the method includes removing an entry from the list of “PLMN not allowed to operate at the present UE location” at the UE upon determining that the UE is successfully registered for the normal services to the PLMN stored in that entry in the list of “PLMN not allowed to operate at the present UE location” via the satellite access network.

In an embodiment, the satellite access network is at least one of a satellite new generation radio access network (NG-RAN) access technology, a satellite Evolved Universal Mobile Telecommunications System (UMTS) Terrestrial Radio Access Network (E-UTRAN) access technology, a Public Land Mobile Network (PLMN) or a Radio Access Technology (RAT).

In an embodiment, the satellite access apparatus is at least one of a Access and Mobility Management Function (AMF) or a Mobility Management Entity (MME).

In an embodiment, each entry in the list of “PLMN not allowed to operate at the present UE location” consists of:
a. PLMN identity of the PLMN which sent a message including a Fifth Generation Mobility Management (5GMM) or a Evolved Universal Mobile Telecommunications System (UMTS) Terrestrial Radio Access Mobility Management (EMM) cause value #78 “PLMN not allowed to operate at the present UE location” via the satellite access network;
b. geographical location, if known by the UE, where the 5GMM or the EMM cause value #78 was received over the satellite access network; and
c. if the geographical location exists, a UE implementation specific distance value.

In an embodiment, determining, by the UE that the UE is successfully registered to the PLMN stored in the list of “PLMN not allowed to operate at the present UE location” via satellite access network for emergency services comprises at least one of:
a. Registering or Attaching by the UE successfully to the PLMN stored in the list of “PLMN not allowed to operate at the present UE location” via satellite access network with at least one of a Fifth Generation System (5GS) Registration type value set to “emergency registration” or a Evolved Packet Subsystem (EPS) Attach type value set to “EPS Emergency Attach” or a Fifth Generation System (5GS) Registration result information element value set to “Registered for emergency services” in any AS or NAS signaling message (For ex-Registration Request message or UE Configuration Update (UCU) message or Detach message or Registration Accept message or Attach Request message or Attach Accept message or Tracking Area Update (TAU) request message or TAU accept message etc.,) or receiving an indication from the satellite access apparatus in a satellite access network that the UE is successfully registered for emergency services or emergency bearer services.

In an embodiment, determining, by the UE that the UE is successfully registered to the PLMN stored in the list of “PLMN not allowed to operate at the present UE location” via satellite access network for normal services comprises at least one of:
a. Registering or Attaching by the UE successfully to the PLMN stored in the list of “PLMN not allowed to operate at the present UE location” via satellite access network with at least one of a Fifth Generation System (5GS) Registration type value not set to “emergency registration” or a Evolved Packet Subsystem (EPS) Attach type value not set to “EPS Emergency Attach” or a Fifth Generation System (5GS) Registration result information element value not set to “Registered for emergency services” in any AS or NAS signaling message (For ex-Registration Request message or UE Configuration Update (UCU) message or Detach message or Registration Accept message or Attach Request message or Attach Accept message or Tracking Area Update (TAU) request message or TAU accept message etc.,) or receiving an indication from the satellite access apparatus in a satellite access network that the UE is successfully registered for normal services or not for emergency bearer services or not for emergency services; or
b. Registering or Attaching by the UE successfully to the PLMN stored in the list of “PLMN not allowed to operate at the present UE location” via satellite access network with at least one of a Fifth Generation System (5GS) Registration type value set to at least one of “initial registration”, mobility registration updating, periodic registration updating, SNPN onboarding registration, disaster roaming mobility registration updating and disaster roaming initial registration, or a Evolved Packet Subsystem (EPS) Attach type value set to at least one of EPS attach, combined EPS/IMSI attach or EPS RLOS attach or a Fifth Generation System (5GS) Registration result information element value set to “Not registered for emergency services” in any AS or NAS signaling message (For ex-Registration Request message or Registration Accept message or UE Configuration Update (UCU) message or Detach message or Attach Request message or Attach Accept message or Tracking Area Update (TAU) request message or TAU accept message etc.,) or receiving an indication from the satellite access apparatus in a satellite access network that the UE is successfully registered for normal services or not for emergency bearer services or not for emergency services.

In an embodiment, removing the entry from the list of “PLMN not allowed to operate at the present UE location” stored at the UE includes removing at least one of an entry of the PLMN, a current geographical location, and a UE implementation specific distance value from the list of “PLMN not allowed to operate at the present UE location” when the UE is successfully registered for normal services to the PLMN stored in that entry in the list of “PLMN not allowed to operate at the present UE location” via satellite access network.

In an embodiment, not removing the entry from the list of “PLMN not allowed to operate at the present UE location” at the UE includes storing or keeping or maintaining or not removing at least one of an entry of the PLMN, a current geographical location; and a UE implementation specific distance value from the list of “PLMN not allowed to operate at the present UE location” when the UE is successfully registered for emergency services to the PLMN stored in that entry in the list of “PLMN not allowed to operate at the present UE location” via satellite access network.

Accordingly, the embodiments herein provide methods for handling a PLMN in a shared RAN. The method includes determining, by a UE, that the UE is available in an overlapping area of a first RAN and a second RAN. The second RAN is a shared RAN. Further, the method includes receiving, by the UE, an indication from one of a Non-access stratum (NAS) message and an access stratum (AS) message. At least one of the NAS message and the AS message is broadcasted from at least one of the first RAN and the second RAN. Further, the method includes determining, by the UE, the received indication indicating a selected PLMN present in the first RAN and in the second RAN. Further, the method includes prioritizing, by the UE, the first RAN over the second RAN for the selected PLMN.

In an embodiment, the first RAN is a Home-RAN (H-RAN) and a second RAN is a Visited-RAN (V-RAN) or a shared RAN.

In an embodiment, the selected PLMN includes at least one of a Home Public Land Mobile Network (HPLMN), an Equivalent HPLMN (EHPLMN), a higher priority PLMN and any allowable PLMN.

Accordingly, the embodiments herein provide methods for handling a PLMN in a shared RAN. The method includes broadcasting, by at least one of a first RAN and a second RAN, at least one of a NAS message and a AS message for a PLMN to a UE. The second RAN is a shared RAN. Further, the method includes receiving, by the UE, a message or indication from at least one of a first RAN and a second RAN to prioritize the first RAN over the second RAN for the selected PLMN based on at least one of the broadcasted NAS message and the broadcasted AS message.

Accordingly, the embodiments herein provide a UE including a PLMN list controller coupled with a processor and a memory. The PLMN list controller is configured to determine whether the UE is successfully registered to the PLMN stored in the list of “PLMN not allowed to operate at the present UE location” via satellite access network for emergency services or normal services. In an embodiment, the PLMN list controller is configured to not remove an entry from the list of “PLMN not allowed to operate at a present UE location” stored at the UE upon determining that the UE is successfully registered for emergency services to the PLMN stored in that entry in the list of “PLMN not allowed to operate at the present UE location” via satellite access network. In another embodiment, the PLMN list controller is configured to remove an entry from the list of “PLMNs not allowed to operate at a present UE location” stored at the UE upon determining that the UE is successfully registered for normal services to the PLMN stored in that entry in the list of “PLMN not allowed to operate at the present UE location” via satellite access network.

Accordingly, the embodiments herein provide a UE including a PLMN selection controller coupled with a processor and a memory. The PLMN selection controller is configured to determine that the UE is available in an overlapping area of a first RAN and a second RAN. The first RAN is a Home-RAN (H-RAN) and the second RAN is a Visited-RAN (V-RAN) (200b) or a shared RAN. Further, the PLMN selection controller is configured to receive an indication from at least one of a NAS message and an AS message. At least one of the NAS message and the AS message is broadcasted from at least one of the first RAN and the second RAN. Further, the PLMN selection controller is configured to determine the received indication indicating a selected PLMN present in the first RAN and the second RAN. Further, the PLMN selection controller is configured to prioritize the first RAN over the second RAN for the selected PLMN.

Accordingly, the embodiments herein provide a first RAN including a PLMN selection controller coupled with a processor and a memory. The PLMN selection controller is configured to broadcast at least one of a NAS message and a AS message for a PLMN to a UE. Further, the PLMN selection controller is configured to broadcast or indicate a message to the UE to prioritize a first RAN over a second RAN for the selected PLMN based on at least one of the broadcasted NAS message and the broadcasted AS message.

These and other aspects of the embodiments herein will be better appreciated and understood when considered in conjunction with the following description and the accompanying drawings. It should be understood, however, that the following de-scriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for methods and apparatuses to handle PLMN list. And more particularly to methods and systems to prioritize home radio access network (RAN) for getting services, and also more specifically to methods and systems for handling of public land mobile network (PLMN) list.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a scenario of a UE in an overlapping area of a Home RAN and a V-RAN, which is a shared RAN, according to prior art;

FIG. 2 illustrates a sequential diagram in which a UE is unable to identify the Home RAN and the V-RAN, according to prior art;

FIG. 3 illustrates an operation of a UE in an overlapping area of a Home RAN and a V-RAN, which is a shared RAN, according to embodiments as disclosed herein;

FIG. 4 illustrates an operations of a UE in an overlapping area of a, Home RAN and a V-RAN, which is a shared RAN during a disaster condition, according to embodiments as disclosed herein;

FIG. 5A-FIG. 5C illustrate a sequential diagram in which the UE identifies the Home RAN and the V-RAN, according to embodiments as disclosed herein;

FIG. 6 illustrates an operational flow diagram depicting a method for handling a PLMN list during an emergency registration, according to the embodiments as disclosed herein;

FIG. 7 illustrates another operational flow diagram depicting a method for handling the PLMN list during the emergency registration, according to the embodiments as disclosed herein;

FIG. 8 shows various hardware components of the UE, according to the embodiments as disclosed herein;

FIG. 9 shows various hardware components of a RAN, according to the embodiments as disclosed herein;

FIG. 10 is a flow chart illustrating a method, implemented by the UE, for handling a PLMN list, according to the embodiments as disclosed herein;

FIG. 11 is a flow chart illustrating a method, implemented by the UE, for handling a PLMN in a shared RAN, according to the embodiments as disclosed herein; and

FIG. 12 is a flow chart illustrating a method, implemented by the RAN, for handling a PLMN in a shared RAN, according to the embodiments as disclosed herein.

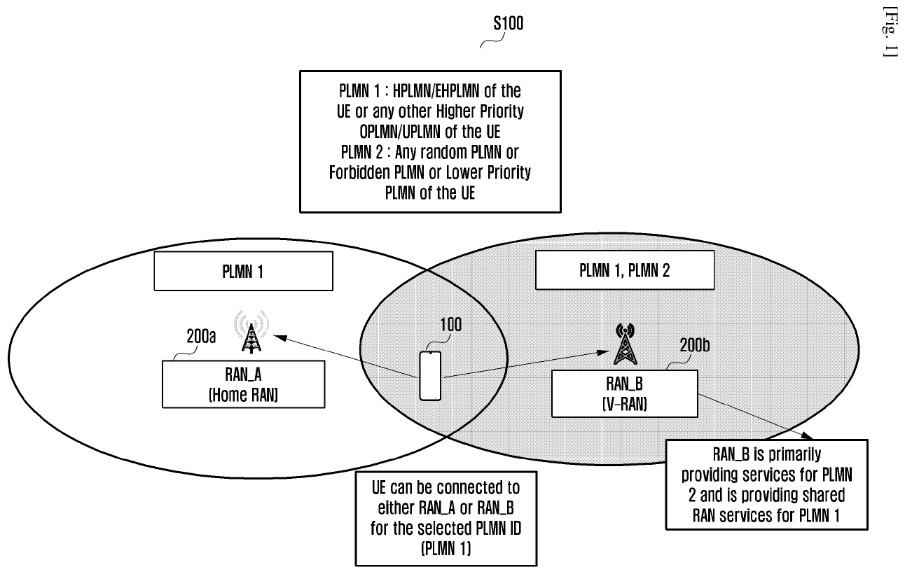

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The embodiments herein and the various features and advantageous details thereof are explained more fully with reference to the non-limiting embodiments that are illustrated in the accompanying drawings and detailed in the following description. De-scriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for handling a PLMN list. The method includes determining, by a UE, whether the UE is successfully registered to the PLMN stored in the list of “PLMN not allowed to operate at the present UE location” via satellite access network for emergency services or normal services. In an embodiment, the method includes not removing an entry from the list of “PLMN not allowed to operate at a present UE location” at the UE upon determining that the UE is successfully registered for emergency services via satellite access network. In another embodiment, the method includes removing an entry from the list of “PLMN not allowed to operate at a present UE location” at the UE upon determining that the UE is successfully registered for normal services via satellite access network.

The proposed method can be used to prioritize home RAN for getting services. The proposed method can be used to handle the PLMN list during emergency registration. In the proposed solution, the UE or MS doesn't removes or doesn't delete the PLMN entry along with current geographical location and the UE implementation specific distance value from the list of “PLMN not allowed to operate at the present UE location” if the registration is successful for emergency services or emergency registration is successful on that PLMN via satellite access network (for ex-satellite NG-RAN access or satellite E-UTRAN access or any 3GPP/Non-3GPP satellite access).

In the embodiment, the UE or MS deletes the PLMN entry along with current geographical location and the UE implementation specific distance value from the list of “PLMNs not allowed to operate at the present UE location”, as emergency registration is successful. In an alternate embodiment, once the emergency registration is successful on the first PLMN, the PLMN entry shall not be removed/deleted from the list of “PLMNs not allowed to operate at the present UE location”. Further the PLMN is removed from the list when: (a) the UE successfully registers via satellite NG-RAN/satellite E-UTRAN access technology to the PLMN stored in the entry via normal registration i.e., not by emergency registration; or (b) the timer associated with the entry of the PLMN has expired.

The below short terms and definition used in the patent disclosure.
1. RAN Radio Access Network
2. H-RAN Home Radio Access Network
3. V-RAN Visited Radio Access Network
4. eNB Evolved Node-B
5. gNB Next generation Node-B
6. EPC Evolved Packet Core
7. 5GC 5G Core
8. 3GPP Third Generation Partnership Project
9. PLMN Public land Mobile Network
10. HPLMN Home Public land Mobile Network
11. EHPLMN Equivalent Home Public land Mobile Network
12. RPLMN Registered PLMN
13. UPLMN User controlled Public land Mobile Network
14. OPLMN Operator controlled Public land Mobile Network
15. VPLMN Visited PLMN
16. NPN Non-Public Network
17. SNPN Stand-alone Non-Public Network
18. PNI-NPN Public Network Integrated Non-Public Network
19. UE User Equipment
20. NTN Non Terrestrial Networks
21. TN Terrestrial Network
22. MS Mobile Station
23. UE User Equipment
24. eNB Evolved Node-B
25. gNB Next generation Node-B
26. EPC Evolved Packet Core
27. 5GC 5G Core
28. NW Network
29. 5GMM 5G NAS Mobility Management
30. NG-RAN Next Generation Radio Access Network
31. NR New Radio
32. EUTRAN Evolved Universal Mobile Telecommunication Access Network
33. PLMN Public Land Mobile Network
34. PLMN ID Public Land Mobile Network Identity
35. 3GPP Third Generation Partnership Project
36. Satellite an artificial body placed in orbit round the earth or moon or another planet in order to collect information or for communication.
37. Satellite Constellation Group of satellites, placed in orbit round the earth or moon or another planet in order to collect information or for communication.
38. Service User An individual who has received a priority level assignment from a regional/national authority (i.e., an agency authorised to issue priority assignments) and has a subscription to a mobile network operator
39. 3GPP Third Generation Partnership Project
40. 4G-GUTI 4G-Globally Unique Temporary Identifier
41. 5G-BRG 5G Broadband Residential Gateway
42. 5GC 5G Core
43. 5GCN 5G Core Network
44. 5G-CRG 5G Cable Residential Gateway
45. 5G-GUTI 5G-Globally Unique Temporary Identifier
46. 5GMM 5G Mobility Management
47. 5G-RG 5G Residential Gateway
48. 5GS 5G System
49. 5GSM 5GS Session Management
50. 5G-S-TMSI 5G S-Temporary Mobile Subscription Identifier
51. 5G-TMSI 5G Temporary Mobile Subscription Identifier
52. 5QI 5G QOS Identifier
53. ACS Auto-Configuration Server
54. AKA Authentication and Key Agreement
55. A-KID AKMA Key Identifier
56. AKMA Authentication and Key Management for Applications
57. AMBR Aggregate Maximum Bit Rate
58. AMF Access and Mobility Management Function
59. APN Access Point Name
60. ARP Allocation and Retention Policy
61. AS Access Stratum
62. A-TID AKMA Temporary Identifier
63. ATSSS Access Traffic Steering, Switching and Splitting
64. AUSF Authentication Server Function
65. CAG Closed access group
66. CAG ID Closed Access Group Identifier
67. CHAP Challenge Handshake Authentication Protocol
68. CU Centralized Unit
69. DC Discontinuous Coverage
70. DisCo Discontinuous Coverage
71. DL Downlink
72. DND Do not Disturb
73. DRX Discontinuous Reception
74. DU Distributed Unit
75. eDRX Extended Discontinuous Reception
76. EHPLMN Equivalent Home Public Land Mobile Network
77. EMM EUTRA Mobility Management
78. eNB Evolved Node-B
79. eNPN Enhanced Non-Public Networks
80. EPC Evolved Packet Core
81. EPLMN Equivalent Public Land Mobile Network
82. EPS Evolved Packet System
83. eSIM embedded Subscriber Identity Module
84. E-UTRA Evolved Universal Mobile Telecommunication Access
85. EUTRAN Evolved Universal Mobile Telecommunication Access Network
86. FPLMN Forbidden Public Land Mobile Network
87. FR Frequency Range
88. GEO Geostationary Orbit
89. GERAN GSM Edge Radio Access Network
90. GERAN EC-GSM-IoT GSM Edge Radio Access Network Extended Coverage-GSM-Internet of Things
91. gNB Next generation Node-B
92. gNB-CU Next generation Node-B Control Unit
93. gNB-DU Next generation Node-B Distributive Unit
94. GPRS General Packet Radio Service
95. GPS Global Positioning System
96. GSM Global System for Mobile Communication
97. HPLMN Home Public Land Mobile Network
98. IAB Integrated access and backhaul
99. IAB-UE The part of the IAB node that supports the Uu interface towards the IAB-donor or another parent IAB-node (and thus manages the backhaul connectivity with either PLMN or SNPN it is registered with) is referred to as an IAB-UE.
100. LADN Local Area Data Network
101. LCS Location services
102. LEO Low Earth Orbit
103. MBSR Mobile Base Station Relay
104. MCC Mobile Country Code
105. MCS Mission Critical Service
106. ME Mobile Equipment
107. MEC Multi-Access Edge Computing
108. MEO Medium Earth Orbit
109. MICO Mobile Initiated Communication Only
110. MINT Minimization of service interruption
111. MME Mobility Management Entity
112. MNC Mobile Network Code
113. MPS Multimedia Priority Service
114. MS Mobile Station. The present document makes no distinction between MS and UE.
115. NAS Non-Access Stratum
116. NB-S1 Mode Narrow Band with S1 Interface
117. NGAP Next Generation Application Protocol
118. NG-RAN Next Generation Radio Access Network
119. NPN Non-Public Networks
120. NR New Radio
121. NTN Non Terrestrial Networks
122. NW Network
123. OOS Out of Service
124. OS Upgrade Operating System Upgrade
125. PDN Packet Data Network
126. PDU Packet Data Unit
127. PLMN ID Public Land Mobile Network Identity
128. PSM Power Saving Mode
129. QOS Quality Of Service
130. RAT Radio Access Technology
131. RPLMN Registered Public Land Mobile Network
132. RRC Radio Resource Control
133. RU Registration Update
134. SAT Satellite
135. Satellite an artificial body placed in orbit round the earth or moon or another planet in order to collect information or for communication.
136. Satellite Constellation Group of satellites, placed in orbit round the earth or moon or another planet in order to collect information or for communication.
137. Service User An individual who has received a priority level assignment from a regional/national authority (i.e., an agency authorised to issue priority assignments) and has a subscription to a mobile network operator
138. SIM Subscriber Identity Module
139. SNPN Standalone Non-Public Networks
140. SUCI Subscription Concealed Identifier
141. SW Software
142. TAC Tracking Area Code
143. TAI Tracking Area Identity
144. TAU Tracking Area Update
145. TER Terrestrial
146. TN Terrestrial Networks
147. UCU UE Configuration Update
148. UDM Unified Data Management Function
149. UE User Equipment
150. UL Uplink
151. ULI User Location Information
152. UPU UE Parameters Update
153. USIM Universal Subscriber Identification Module
154. Uu The radio interface between the UE and the Node B
155. VMR Vehicle Mounted Relay
156. VPLMN Visited Public Land Mobile Network
157. WB-S1 Mode Wide Band with S1 Interface
158. Visited PLMN (VPLMN): This is a PLMN different from the HPLMN (if the EHPLMN list is not present or is empty) or different from an EHPLMN (if the EHPLMN list is present).
159. Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.
160. Available PLMN: PLMN(s) in the given area which is/are broadcasting capability to provide wireless communication services to the UE.
161. Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.
162. EHPLMN: Any of the PLMN entries contained in the Equivalent HPLMN list.
163. Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it shall be treated as a Visited PLMN for PLMN selection purposes.
164. Home PLMN: This is a PLMN where the MCC and MNC of the PLMN identity match the MCC and MNC of the IMSI.
165. Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.
166. Registration: This is the process of camping on a cell of the PLMN or the SNPN and doing any necessary LRs.
167. UPLMN: PLMN/access technology combination in the “User Controlled PLMN Selector with Access Technology” data file in the SIM (in priority order);
168. OPLMN: PLMN/access technology combination in the “Operator Controlled PLMN Selector with Access Technology” data file in the SIM (in priority order) or stored in the ME (in priority order)
169. Home RAN (H-RAN): It is the RAN (RADIO access network) infrastructure deployed or owned by home PLMN ID or the primary PLMN ID or Higher Priority PLMN ID selected by the UE (100). Here, the home PLMN ID is an example, it can be any of the HPLMN, EHPLMN, or OPLMN or any allowable PLMN or random PLMN (which is not configured in the UE as per the steering of roaming procedures).
170. Visited RAN (V-RAN): It is the RAN infrastructure deployed or owned by a partner operator (VPLMN) which also broadcasts HPLMN ID or the primary PLMN ID or Higher Priority PLMN ID selected by the UE. The Visited RAN (V-RAN) provides RAN services on behalf of the home PLMN ID or the primary PLMN ID or Higher Priority PLMN ID selected by the UE. Here, the home PLMN ID is an example, it can be any of the HPLMN, EHPLMN, or OPLMN or any allowable PLMN or random PLMN (which is not configured in the UE as per the steering of roaming procedures).
171. PLMN ID: Public Land Mobile Network Identity/Identifier

Below are example list of NAS messages (and not limited to):
a) REGISTRATION REQUEST message;
b) DEREGISTRATION REQUEST message;
c) SERVICE REQUEST message; and
d) CONTROL PLANE SERVICE REQUEST.
e) IDENTITY REQUEST
f) AUTHENTICATION REQUEST;
g) AUTHENTICATION RESULT;
h) AUTHENTICATION REJECT;
i) REGISTRATION REJECT
j) REGISTRATION ACCEPT
k) DEREGISTRATION ACCEPT
l) SERVICE REJECT
m) SERVICE ACCEPT
n) UE CONFIGURATION UPDATE command
o) UE PARAMETERS UPDATE command

The term 5GMM sublayer states in this embodiment are at least one of the below:
1) 5GMM-NULL
2) 5GMM-DEREGISTERED
   a) 5GMM-DEREGISTERED.NORMAL-SERVICE
   b) 5GMM-DEREGISTERED.LIMITED-SERVICE
   c) 5GMM-DEREGISTERED.ATTEMPTING-REGISTRATION
   d) 5GMM-DEREGISTERED.PLMN-SEARCH
   e) 5GMM-DEREGISTERED.NO-SUPI
   f) 5GMM-DEREGISTERED.NO-CELL-AVAILABLE
   g) 5GMM-DEREGISTERED.eCALL-INACTIVE
   h) 5GMM-DEREGISTERED.INITIAL-REGISTRATION-NEEDED
3) 5GMM-REGISTERED-INITIATED
4) 5GMM-REGISTERED
   a) 5GMM-REGISTERED.NORMAL-SERVICE
   b) 5GMM-REGISTERED.NON-ALLOWED-SERVICE
   c) 5GMM-REGISTERED.ATTEMPTING-REGISTRATION-UPDATE
   d) 5GMM-REGISTERED.LIMITED-SERVICE
   e) 5GMM-REGISTERED.PLMN-SEARCH
   f) 5GMM-REGISTERED.NO-CELL-AVAILABLE
   g) 5GMM-REGISTERED.UPDATE-NEEDED
5) 5GMM-DEREGISTERED-INITIATED
6) 5GMM-SERVICE-REQUEST-INITIATED

In this embodiment, the term EMM sublayer states are at least one of the below:
1) EMM-NULL
2) EMM-DEREGISTERED
   a) EMM-DEREGISTERED.NORMAL-SERVICE
   b) EMM-DEREGISTERED.LIMITED-SERVICE
   c) EMM-DEREGISTERED.ATTEMPTING-TO-ATTACH
   d) EMM-DEREGISTERED.PLMN-SEARCH
   e) EMM-DEREGISTERED.NO-IMSI
   f) EMM-DEREGISTERED.ATTACH-NEEDED
   g) EMM-DEREGISTERED.NO-CELL-AVAILABLE
   h) EMM-DEREGISTERED.eCALL-INACTIVE
3) EMM-REGISTERED-INITIATED
4) EMM-REGISTERED
   a) EMM-REGISTERED.NORMAL-SERVICE
   b) EMM-REGISTERED.ATTEMPTING-TO-UPDATE
   c) EMM-REGISTERED.LIMITED-SERVICE
   d) EMM-REGISTERED.PLMN-SEARCH
   e) EMM-REGISTERED.UPDATE-NEEDED
   f) EMM-REGISTERED.NO-CELL-AVAILABLE
   g) EMM-REGISTERED.ATTEMPTING-TO-UPDATE-MM
   h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The term RAT as defined in this embodiment can be one of the following:
a) NG-RAN,
b) 5G, 4G, 3G, 2G,
c) EPS, 5GS,
d) NR,
e) NR in unlicensed bands,
f) NR (LEO) satellite access,
g) NR (MEO) satellite access,
h) NR (GEO) satellite access,
i) NR (OTHERSAT) satellite access,
j) NR RedCap,
k) E-UTRA,
l) E-UTRA in unlicensed bands,
m) NB-IoT,
n) WB-IoT, and
o) LTE-M.

5GS registration type are Initial registration, mobility registration, updating periodic registration, updating emergency registration, and SNPN onboarding registration, “disaster roaming initial registration; or “disaster roaming mobility registration updating”

Normal registration or normal Attach or registered for normal services means at least one of:
a) Setting the 5GS registration type to at least one of:
   initial registration
   mobility registration updating
   periodic registration updating
   SNPN onboarding registration
   “disaster roaming initial registration; or
   “disaster roaming mobility registration updating”
b) Setting the EPS Attach Type to at least one of:
   a. EPS attach
   b. combined EPS/IMSI attach
   c. EPS RLOS attach
c) Setting the 5GS registration result IE value to “Not registered for emergency services”
d) Any AS/NAS indication to/from the Network/UE that the UE is registered for normal services and/or not registered for emergency services/emergency bearer services.

Emergency registration or emergency services or emergency bearer services means at least one of:
a) Setting the 5GS registration type to emergency registration; or
b) Setting the EPS Attach Type to EPS emergency attach; or
c) Setting the 5GS registration result IE value to “Registered for emergency services”
d) Any AS/NAS indication to/from the Network/UE that the UE is registered for emergency services or emergency bearer services and/or UE is not registered for normal services.

PLMN selection as per 23.122 without RPLMN: The MS selects and attempts registration on any PLMN/access technology combinations, if available and allowable, in the following order:
a) either the HPLMN (if the EHPLMN list is not present or is empty) or the highest priority EHPLMN that is available (if the EHPLMN list is present);
b) each PLMN/access technology combination in the “User Controlled PLMN Selector with Access Technology” data file in the SIM (in priority order);
c) each PLMN/access technology combination in the “Operator Controlled PLMN Selector with Access Technology” data file in the SIM (in priority order) or stored in the ME (in priority order);
d) other PLMN/access technology combinations with received high quality signal in random order;
e) other PLMN/access technology combinations in order of decreasing signal quality.

PLMN selection as per 23.122 with RPLMN: The MS selects and attempts registration on any PLMN/access technology combinations, if available and allowable, in the following order:
a) either the RPLMN or the Last registered PLMN;
b) either the HPLMN (if the EHPLMN list is not present or is empty) or the highest priority EHPLMN that is available (if the EHPLMN list is present);
c) each PLMN/access technology combination in the “User Controlled PLMN Selector with Access Technology” data file in the SIM (in priority order);
d) each PLMN/access technology combination in the “Operator Controlled PLMN Selector with Access Technology” data file in the SIM (in priority order) or stored in the ME (in priority order);
e) other PLMN/access technology combinations with received high quality signal in random order;
f) other PLMN/access technology combinations in order of decreasing signal quality.

The terms list of “PLMN not allowed to operate at the present UE location” and list of “PLMNs not allowed to operate at the present UE location” are interchangeably used and have the same meaning.

The terms satellite NG-RAN access and satellite E-UTRAN access are used for illustration purpose and the proposed embodiment is applicable to any 3GPP satellite access, any Non-3GPP satellite access, satellite NG-RAN access and satellite E-UTRAN access.

The terms UE and MS are used interchangeably in this embodiment and have the same meaning.

The term area/location/geographical area are used in this embodiment may refer to any of cell/cell ID, TAC/TAI, PLMN, MCC/MNC, Latitude/longitude, CAG cell or any geographical location/coordinate.

The solutions explained in this embodiment are applicable to any (but not limited to) of the RAT(s) as defined in this embodiment.

The Network used in this embodiment could be any 5G/EUTRAN Core Network Entities like AMF/SMF/MME/UPF or the Network could be any (but not limited to) 5G/EUTRAN RAN Entity like eNodeB (eNB) or gNodeB (gNB) or NG-RAN etc.

The terms Satellite 3GPP access, Satellite access, Satellite Access Network, NR Satellite Access Network, Satellite NG-RAN Access Technology and NR Satellite access have been interchangeably used and have the same meaning.

The methods, issues or solutions disclosed in this embodiment are explained using NR satellite access or Satellite NG-RAN Access Technology as an example and is not restricted or limited to NR Satellite access only. However, the solutions proposed in this embodiment are also applicable for Satellite E-UTRAN access Technology, NB (Narrow Band)-S1 mode or WB (Wide Band)-S1 mode via satellite E-UTRAN access and/or NB-IoT (NarrowBand Internet Of Things) or WB-IoT (WideBand Internet Of Things) Satellite Access/Architecture.

The solutions which are defined for NR (5GC) are also applicable to legacy RATs like E-UTRA/LTE, the corresponding CN entities needs to be replaced by LTE entities for e.g. AMF with MME, g-nodeB with e-nodeB, UDM with HSS etc. But principles of the solution remains same.

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The Network used in this embodiment is explained using any 5G Core Network Function for e.g. AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The messages used or indicated in this embodiment are shown as an example. The messages could be any signalling messages between UE and the Network Functions/Entities or between different Network functions/entities.

The term area/location/geographical area are used in this embodiment may refer to any of cell/cell ID, TAC/TAI, PLMN, MCC/MNC, Latitude/longitude, CAG cell or any geographical location/coordinate.

The methods, issues or solutions disclosed in this embodiment are explained using NR access or NG-RAN Access Technology as an example and is not restricted or limited to NR access only. However, the solutions proposed in this embodiment are also applicable for E-UTRAN access Technology, NB (Narrow Band)-S1 mode or WB (Wide Band)-S1 mode via E-UTRAN access and/or NB-IoT (NarrowBand Internet Of Things) or WB-IoT (WideBand Internet Of Things) Access/Architecture.

The solutions which are defined for NR (5GC) are also applicable to legacy RATs like E-UTRA/LTE, the corresponding CN entities needs to be replaced by LTE entities for e.g. AMF with MME, g-nodeB with e-nodeB, UDM with HSS etc. But principles of the solution remains same.

The Network used in this embodiment is explained using any 5G Core Network Function for e.g. AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The messages used or indicated in this embodiment are shown as an example. The messages could be any signalling messages between UE and the Network Functions/Entities or between different Network functions/entities.

The terms camp and register are used interchangeably and have the same meaning.

The term area as used in this embodiment may refer to any of cell/cell ID, TAC/TAI, PLMN, MCC/MNC, Latitude/longitude, any CAG/CAG identifier or any geographical location/coordinate.

For the list of possible NAS messages please refer to 3GPP TS 24.501 or 3GPP TS 24.301, for list of AS messages please refer to 3GPP TS 38.331 or 3GPP TS 36.331

The cause names in this embodiment are for illustration purpose and it can have any name. The non access stratum (NAS) messages and access stratum (AS) messages described in this embodiment is only for illustration purpose it can be any NAS or AS messages as per defined protocol between UE and AMF/MME or UE and gNB (NG-RAN/any RAN node)/eNB.

The Shared RAN used in this embodiment can be any deployment from the Network where the RAN is shared. The Shared RAN can be at least one of (but not limited or restricted to) Direct Network Sharing without any indirect connection to host operator's core network (i.e. where the Shared Access Network/Shared RAN/NG-RAN might be directly connected to the participating operators' Core Network) or Indirect Network Sharing (i.e. where the shared access network/Shared RAN/NG-RAN is common for multiple operators which is connected to participating operator's core network via Host operator's core network)

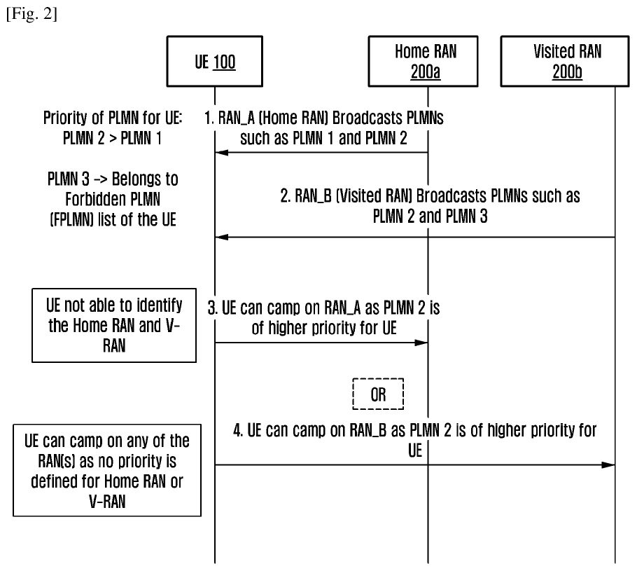

Referring now to the drawings, and more particularly to FIG. 2 to FIG. 12, where similar reference characters denote corresponding features consistently throughout the figures, there are shown at least one embodiment.

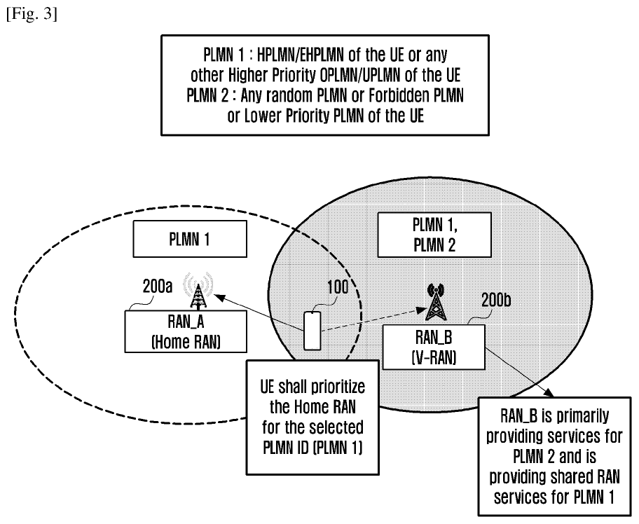

FIG. 3 illustrates an operations of the UE in an overlapping area of a Home RAN and a V-RAN, which is a shared RAN, according to embodiments as disclosed herein.

In an embodiment, the UE (100) prioritizes the Home-RAN (200a) over the V-RAN (200b) for the selected PLMN (for ex-any of HPLMN/EHPLMN or any higher priority PLMN or any allowable PLMN if available) if the same selected PLMN is broadcasted or indicated via any AS/NAS signalling message or services for the same selected PLMN is provided by multiple RAN(s) (for ex-Home-RAN (200a) and V-RAN (200b)).

Hence there shall be a mechanism for UE (100) to prioritize the selection of the Home-RAN (200a) over the V-RAN (200b) for any selected PLMN if the selected PLMN (for ex-HPLMN/EHPLMN or any higher priority PLMN or any allowable PLMN (i.e. not a part of UE's forbidden PLMN List) of the UE) is available and broadcasted by multiple RAN node(s). The UE shall prioritize the Home-RAN over the V-RAN in such situations.

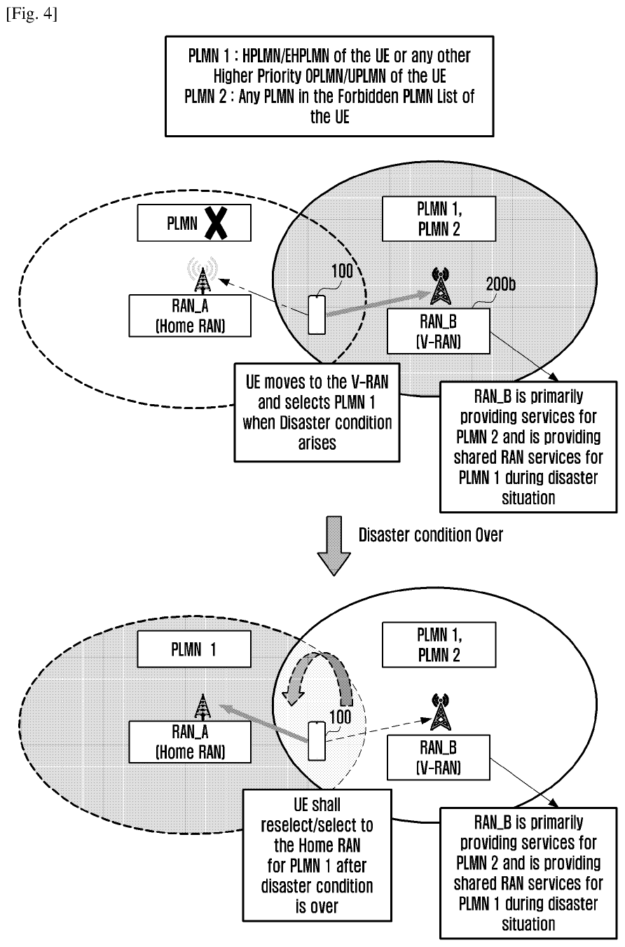

FIG. 4 illustrates an operations of the UE in an overlapping area of a Home RAN and a V-RAN, which is a shared RAN during a disaster condition, according to embodiments as disclosed herein.

When the disaster condition has ended or the UE (100) detects that the disaster condition is no more applicable, the UE (100) selects or reselects or triggers any existing procedure to select the HPLMN/EHPLMN or any higher priority PLMN of the Home RAN (200a). If the UE (100) is camped on the V-RAN (200b) for a selected PLMN (which is an allowable PLMN for the UE (100) and is not a part of UE's forbidden PLMN list) and if the same selected PLMN or any higher priority PLMN of the UE (100) is available/is broadcasted or is indicated via any AS or NAS signalling message by the Home-RAN (200a), the UE (100) performs the PLMN search or the PLMN selection and prioritise or reselects or registers or selects or camps or triggers any existing procedure to select the Home-RAN (200a) over V-RAN (200b) for the selected PLMN.

Hence there shall be a mechanism for UE (100) to select/reselect/register/camp/prioritize the Home-RAN (200a) over the V-RAN (200b) for HPLMN/EHPLMN or any higher priority PLMN of the UE (100) when the home RAN (200a) or the V-RAN (200b) is broadcasted or indicated via any AS or NAS signalling after the disaster condition is over or disaster situation has ended. The UE shall prioritize Home-RAN over the V-RAN in such situations.

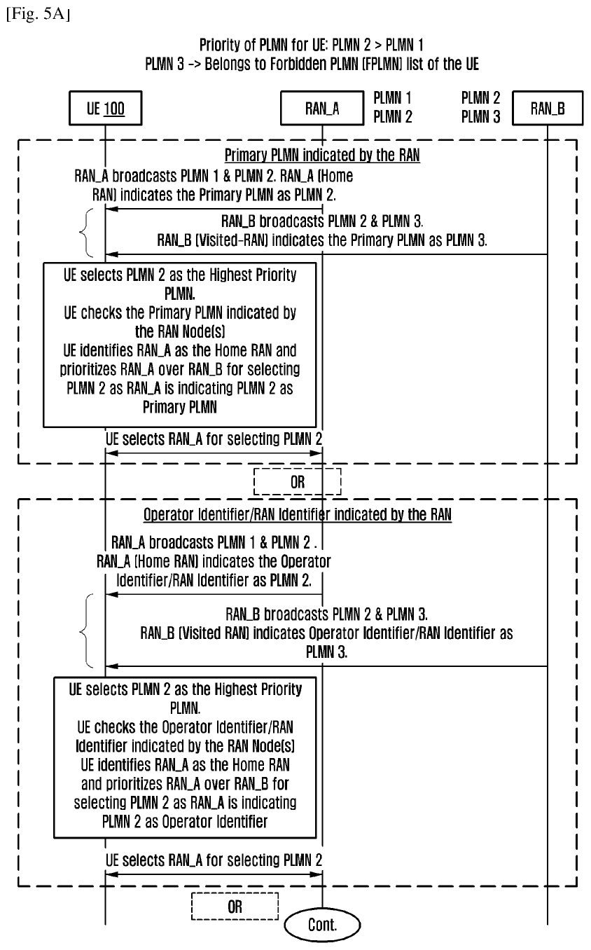

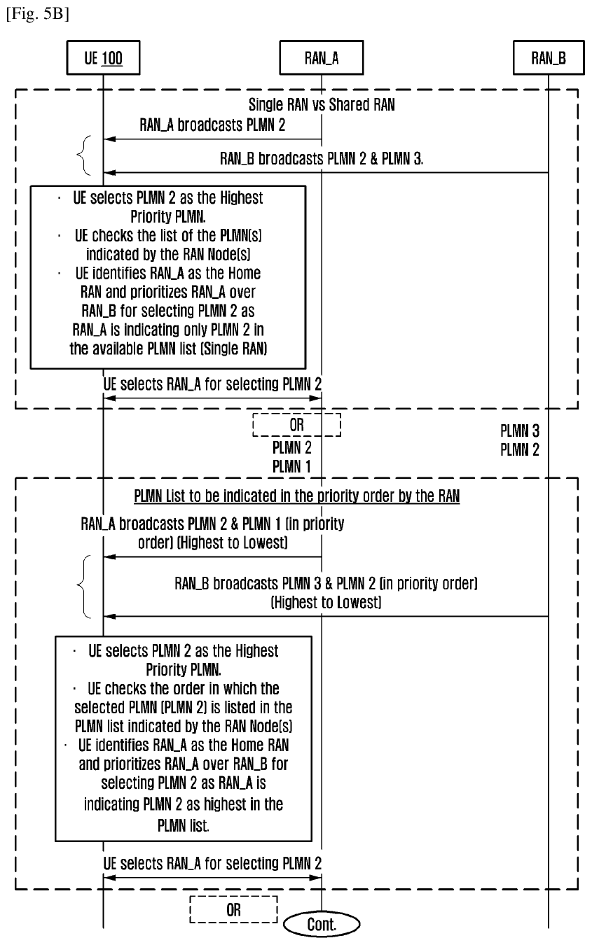

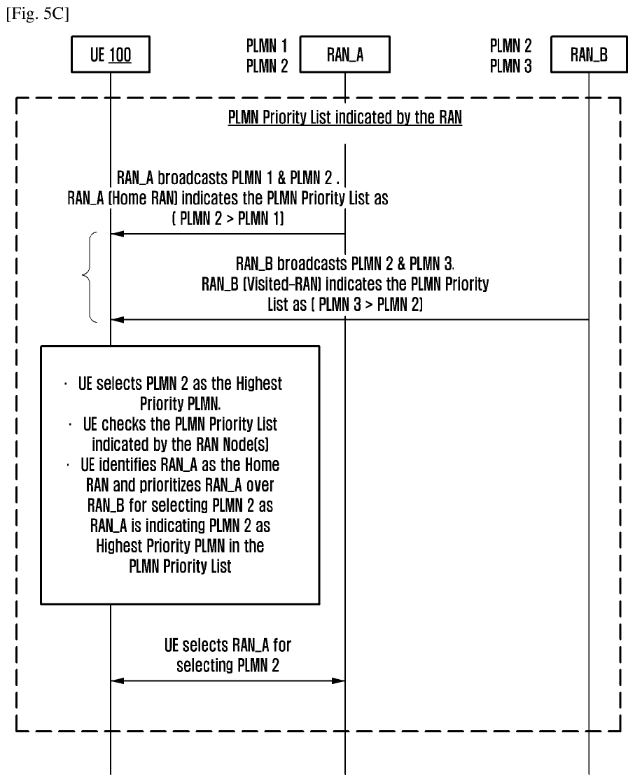

FIG. 5A-FIG. 5C illustrate a sequential diagram in which the UE (100) identifies the Home RAN (200a) and the V-RAN (200b), according to embodiments as disclosed herein.

In an embodiment, the UE (100) identifies and differentiates or prioritizes among the multiple RAN(s) (for e.g. Home RAN (200a) or V-RAN (200b)) broadcasting the selected PLMN or indicating the selected PLMN via any AS or NAS signalling message using at least one of the (but not restricted or limited to) below methods or procedures in any order or combination:

Primary PLMN indicated by the RAN: In an embodiment, the network or the RAN node(s) broadcasts or indicates via any AS or NAS signalling message using any indication or IE to indicate its primary PLMN among the list of PLMN(s) for which the RAN node(s) is providing service. The primary PLMN can be the HPLMN/EHPLMN/OPLMN/UPLMN or any higher priority PLMN of the Operator of the RAN node and shall be one of the PLMN(s) broadcasted by the RAN Node(s). When the UE (100) identifies that there are more than one RAN node(s) which are providing service for the same PLMN (which may be any of the HPLMN/EHPLMN/OPLMN/UPLMN or any higher priority PLMN of the UE) and the selected PLMN is currently the highest priority PLMN of the UE (100), the UE (100) determines the primary PLMN as indicated by the RAN node(s) in the broadcast or indicated in the IE or in the AS/NAS signalling message. If the selected PLMN of the UE (100) matches with the primary PLMN of any of the RAN node(s), the UE (100) identifies that the RAN node is the Home RAN (200a) for the selected PLMN. Optionally, the UE (100) prioritizes the RAN node over other RAN node(s) for PLMN selection. If there are more than one RAN node(s) which indicates the primary PLMN as same as the UE's selected PLMN, the UE (100) may identify any of these RAN Node(s) as the Home RAN (200a) and may, optionally, select/prioritize any of the RAN Node(s) in the random order or implementation specific manner.

Operator Identifier/RAN Identifier indicated by the RAN: In an embodiment, the network or the RAN node(s) broadcasts or indicates via any AS or NAS signalling message using any indication or the IE to indicate the Operator Identifier/RAN identifier for which the RAN node(s) is providing service. The operator identifier is used to indicate the operator (i.e., PLMN) to which the RAN node belongs to and can be the HPLMN/EHPLMN/OPLMN/UPLMN of the operator of the RAN node. When the UE (100) identifies that there are more than one RAN node(s) which are providing service for the same PLMN (which may be any of the HPLMN/EHPLMN/OPLMN/UPLMN or any higher priority PLMN of the UE (100)) and the selected PLMN is currently the highest priority PLMN of the UE (100), the UE (100) checks the operator identifier as indicated by the RAN node(s) in the broadcast or indicated in the IE or in AS/NAS signalling message. The UE (100) identifies the RAN node as the home RAN (200a) and optionally prioritize the RAN Node (over other RAN Node(s)) for the PLMN selection whose operator identifier (PLMN) is having higher priority for the UE (100) as per UE's Preferred PLMN List as per 23.122 or UE's Preferred PLMN List as per 23.122 excluding RPLMN as defined in this embodiment. If there are more than one RAN node(s) whose Operator Identifier (PLMN) is having the same priority as per UE's Preferred PLMN List as per 23.122 or UE's Preferred PLMN List as per 23.122 excluding RPLMN, the UE (100) may identify any of these RAN Node(s) as the Home RAN (200a) and may, optionally, select/prioritize any of the RAN Node(s) in random order or implementation specific manner.

Single RAN vs Shared RAN: When the UE (100) identifies that there are more than one RAN node(s) which are providing service (via broadcast or indicating via any AS or NAS signalling message) for the same PLMN (which may be any of the HPLMN/EHPLMN/OPLMN/UPLMN or any higher priority PLMN of the UE (100)) and the selected PLMN is currently the highest priority PLMN of the UE (100), the UE (100) determines the list of the PLMN(s) broadcasted by the available RAN Node(s) which are broadcasting or indicating via any AS or NAS signalling message the UE's selected PLMN. If the RAN node is broadcasting or indicating via any AS or NAS signalling message only the selected PLMN of the UE (100) and other RAN Node(s) are broadcasting or indicating via any AS or NAS signalling message some additional PLMN(s) along with the selected PLMN of the UE (100), the UE (100) identifies that the RAN node is the Home RAN (200a) for the selected PLMN. Optionally, the UE (100) prioritizes the RAN Node(s) which broadcasts or indicates in the AS/NAS signalling message, only the PLMN selected by the UE (100) for the PLMN selection. If there are more than one RAN node(s) which broadcasts only the selected PLMN of the UE (100), the UE (100) may identify any of these RAN Node(s) as the Home RAN (200a) and may, optionally, select/prioritize any of the RAN Node(s) in random order or implementation specific manner.

PLMN List to be indicated in Priority order by the RAN: In an embodiment, the network or the RAN node(s) broadcasts or indicates via any AS or NAS signalling message the list of PLMN(s) for which the RAN node(s) is providing service in the priority order. The list of PLMN(s) broadcasted by the RAN node(s) shall be in the order of priority as per the priority of the services/operators/Operator(s)'s PLMN(s) as agreed by the RAN Node(s)'s operator. The first PLMN in the list of the PLMN(s) has the highest priority for that the RAN node followed by the second PLMN in the list of the PLMN(s) and so on. When the UE (100) identifies that there are more than one RAN node(s) which are providing service for the same PLMN (which may be any of the HPLMN/EHPLMN/OPLMN/UPLMN or any higher priority PLMN of the UE (100) and the selected PLMN is currently the highest priority PLMN of the UE (100), the UE (100) determines the order in which the selected PLMN is listed in the list of PLMN(s) being broadcasted by the RAN Node(s). The UE (100) identifies that the RAN node is the Home RAN (200a) for the selected PLMN and optionally, the UE (100) prioritizes the RAN node (over other RAN Node(s)) for PLMN selection which is broadcasting or indicating in the AS/NAS signalling message the UE's selected PLMN as the first PLMN in the list of PLMN(s) for which the RAN Node(s) is providing service to the UE (100). If there are more than one RAN node(s) which is broadcasting or indicating in the AS/NAS signalling message the UE's selected PLMN as the first PLMN in the list of PLMN(s) for which the RAN Node(s) is providing service to the UE (100), the UE (100) may identify any of these RAN Node(s) as the Home RAN (200a) and may, optionally, select/prioritize any of the RAN Node(s) in random order or implementation specific manner. If none of the RAN Node(s) is broadcasting the UE's selected PLMN as the first PLMN in the list of PLMN(s) for which the RAN Node(s) is providing service to the UE (100), the UE (100) may select/prioritize the RAN node which is broadcasting or indicating in the AS/NAS signalling message the UE's selected PLMN as better in the order of priority of PLMN(s) for which the RAN Node(s) is providing service to the UE (100) among all the available RAN Node(s) providing service for the selected PLMN or in random order or implementation specific manner.

PLMN Priority List by the RAN: In an embodiment, the network or the RAN node(s) broadcasts or indicates via any AS or NAS signalling message using any indication or Information Element (IE) to indicate the priority order of the PLMN(s) present in the list of PLMN(s) for which the RAN node(s) is providing service. The indicated priority order of the PLMN(s) may be in the order of priority as per the priority of the services/operators/Operator(s)'s PLMN(s) as agreed by the RAN Node(s)'s operator. When the UE (100) identifies that there are more than one RAN node(s) which are providing service for the same PLMN (which may be any of the HPLMN/EHPLMN/OPLMN/UPLMN or any higher priority PLMN of the UE) and the selected PLMN is currently the highest priority PLMN of the UE (100), the UE (100) determines the priority order indicated by the RAN Node(s) for the selected PLMN. The UE (100) identifies that the RAN node is the Home RAN (200a) for the selected PLMN and optionally, the UE (100) prioritizes the RAN node (over other RAN Node(s)) for PLMN selection which is broadcasting or indicating in the IE or the AS/NAS signalling message the UE's selected PLMN as the highest priority as per the priority order indicated by the RAN Node(s) among the list of PLMN(s) for which the RAN Node(s) is providing service to the UE (100). If there are more than one RAN node(s) which is broadcasting the UE's selected PLMN as the highest priority as per the priority order indicated by the RAN Node(s) among the list of PLMN(s) for which the RAN Node(s) is providing service to the UE (100), the UE (100) identifies any of these RAN Node(s) as the Home RAN (200a) and may, optionally, select/prioritize any of the RAN Node(s) in random order or implementation specific manner. If none of the RAN Node(s) is broadcasting or indicating in the IE or the AS/NAS signalling message the UE's selected PLMN as the highest priority as per the priority order indicated by the RAN Node(s) among the list of PLMN(s) for which the RAN Node(s) is providing service to the UE (100), the UE (100) may select/prioritize the RAN node which is broadcasting or indicating in the IE or the AS/NAS signalling message the UE's selected PLMN as higher in priority as per the priority order indicated by the RAN Node(s) among the list of PLMN(s) for which the RAN Node(s) is providing service to the UE (100) among all the available RAN Node(s) providing service for the selected PLMN or in random order or implementation specific manner.

Cell Identifier or RAN identifier: In an embodiment, the network or the RAN node(s) broadcasts or indicates via any AS or NAS signalling message using any indication or Information Element (IE) to indicate the Cell identifier or RAN identifier (for ex-Cell Global Identifier/Identity (CGI) or E-UTRAN Cell Identifier (ECI) or NR Cell Identifier (NCI) etc). The UE uses this Cell Identifier to identify the operator (i.e., PLMN) to which the RAN node belongs to and can be the HPLMN/EHPLMN/OPLMN/UPLMN of the operator of the RAN node. When the UE (100) identifies that there are more than one RAN node(s) which are providing service for the same PLMN (which may be any of the HPLMN/EHPLMN/OPLMN/UPLMN or any higher priority PLMN of the UE (100)) and the selected PLMN is currently the highest priority PLMN of the UE (100), the UE (100) checks the Cell Identifier or the RAN identifier as indicated by the RAN node(s) in the broadcast or indicated in the IE or in AS/NAS signalling message. The UE (100) identifies the RAN node as the home RAN (200a) and optionally prioritize the RAN Node (over other RAN Node(s)) for the PLMN selection whose operator identifier (PLMN) is having higher priority for the UE (100) as per UE's Preferred PLMN List as per 23.122 or UE's Preferred PLMN List as per 23.122 excluding RPLMN as defined in this embodiment. If there are more than one RAN node(s) whose Operator Identifier (PLMN) is having the same priority as per UE's Preferred PLMN List as per 23.122 or UE's Preferred PLMN List as per 23.122 excluding RPLMN, the UE (100) may identify any of these RAN Node(s) as the Home RAN (200a) and may, optionally, select/prioritize any of the RAN Node(s) in random order or implementation specific manner.

The UE (100) or the network or both may select all or any of the above solutions in random order or in any implementation specific manner.

All the procedures defined in this embodiment are applicable during, but not limited to, any of the below situations or procedures:
i. When the UE (100) performs PLMN selection or PLMN search or reselection or the UE (100) performs the location registration or when the user may request the UE (100) to initiate reselection and registration onto an available PLMN, or
ii. When the UE (100) is in the VPLMN and the UE (100) periodically attempts to obtain the service on its HPLMN (if the EHPLMN list is not present or is empty) or one of its EHPLMNs (if the EHPLMN list is present) or a higher priority PLMN/access technology combinations listed in “user controlled PLMN selector” or “operator controlled PLMN selector”, or
iii. When the UE (100) performs either Automatic Network Selection Mode Procedure or Manual Network Selection Mode Procedure, or
iv. When the UE (100) performs any of the above or related procedures at switch-on or recovery from lack of coverage or during SIM removal and insertion, or
v. When the UE (100) performs any of the above or related procedures during or at the end of a disaster situation. The disaster situation may be, but not limited to, 5GC disaster or NG-RAN disaster.

All the procedures defined in this embodiment are applicable, but not limited to, when the PLMN is replaced by any of below terms or any of the below parameters/terms are used instead of or in conjunction with the PLMN:
i. SNPN,
ii. NPN,
iii. Hosting Network,
iv. Localised Service Provider,
v. PNI-NPN,
vi. RAT, and
vii. Network slice.

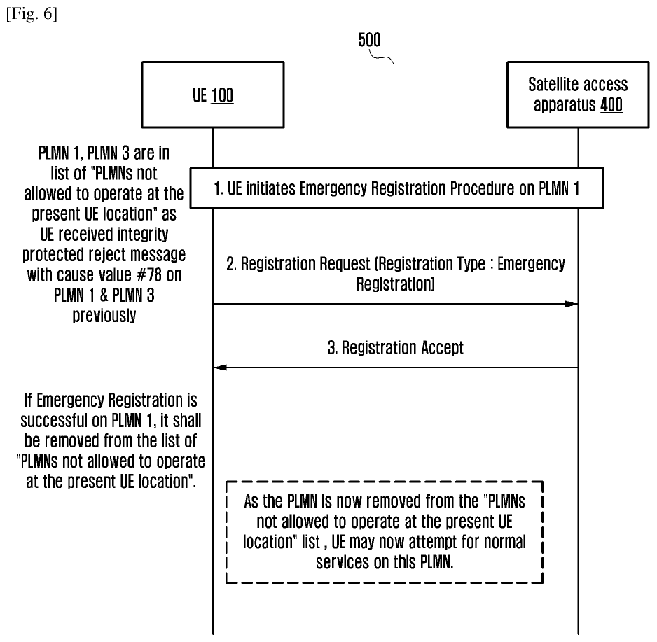

FIG. 6 illustrates an operational flow diagram depicting a method for handling the PLMN list during the emergency registration, according to the embodiments as disclosed herein.

In an embodiment, when the UE (100) or the mobile station (MS) attempts to get the emergency service via the emergency registration (for ex-using 5GS registration type value as emergency registration or EPS attach type value as EPS emergency attach or 5GS registration result IE value set to “Registered for emergency services” or via any AS/NAS signalling message or indication) on the PLMN via the satellite NG-RAN/satellite E-UTRAN/any 3GPP or Non-3GPP Satellite access technology, which has an entry in the list of “PLMN not allowed to operate at the present UE location” present or stored in the UE (100) or the MS, and it gets emergency services or emergency bearer services from the PLMN via satellite NG-RAN/satellite E-UTRAN/any 3GPP or Non-3GPP Satellite access technology, the UE (100) or the MS removes or deletes the PLMN entry along with current geographical location and the UE implementation specific distance value from the list if the registration is successful for the emergency services or the emergency registration is successful.

When the first PLMN (i.e., PLMN 1) and third PLMN (i.e., PLMN 3) are in list of “PLMN not allowed to operate at the present UE location” as the UE (100) received integrity protected reject message with 5GMM or EMM cause value #78 on the first PLMN and the third PLMN previously and includes:

At step 1 and step 2, the UE (100) initiates the registration procedure with the registration type as the emergency registration (for ex-using 5GS registration type value as emergency registration or EPS attach type value as EPS emergency attach or via any AS/NAS signalling message or indication) on the first PLMN via satellite NG-RAN/satellite E-UTRAN/any 3GPP or Non-3GPP Satellite access technology, for the emergency services for instance an emergency call.

At step 3, the network (NW) or the AMF or the MME sends the RA (Registration accept) or Attach Accept message to the UE (100) or MS on the first PLMN after successful emergency registration (for ex-using 5GS registration type value as emergency registration or EPS attach type value as EPS emergency attach or 5GS registration result IE value set to “Registered for emergency services” or via any AS/NAS signalling message or indication) for the emergency services or emergency bearer services.

At step 4, the method includes removing/deleting the PLMN from the list of “PLMN not allowed to operate at the present UE location”, as the emergency registration is successful on the first PLMN. The UE (100) may optionally attempt for normal services on the removed PLMN, as the PLMN is removed from the “PLMN not allowed to operate at the present UE location” list.

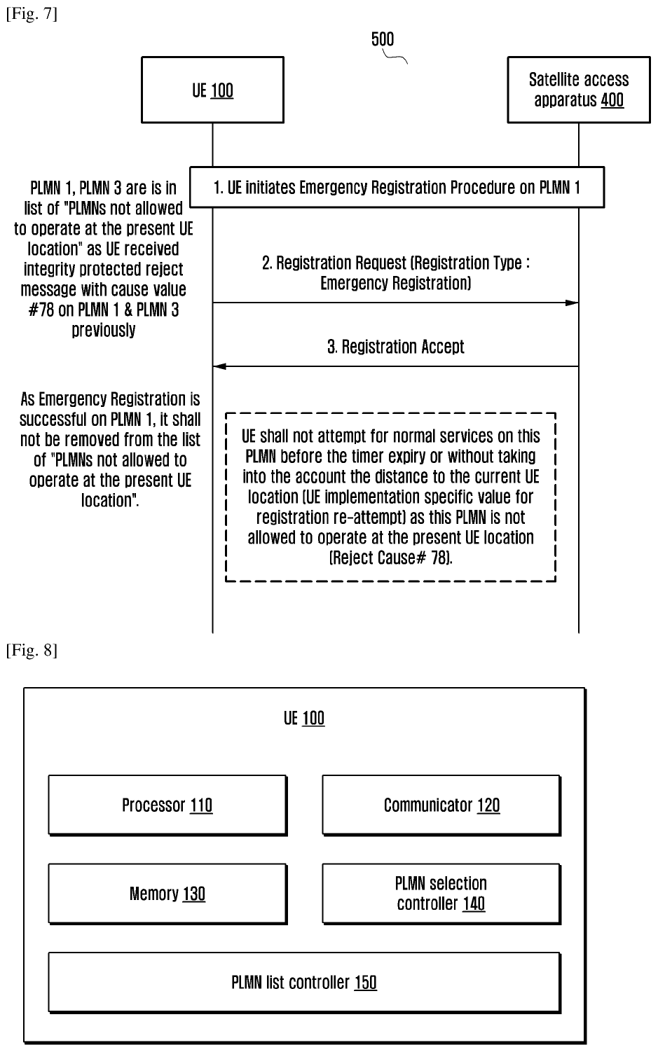

FIG. 7 illustrates an operational flow diagram depicting a method for handling the PLMN list during the emergency registration, according to the embodiments as disclosed herein.

In an embodiment, when the UE (100) or the MS attempts to get emergency service via the emergency registration (for ex-using 5GS registration type value as emergency registration or EPS attach type value as EPS emergency attach or 5GS registration result IE value set to “Registered for emergency services” or via any AS/NAS signalling message or indication) on the PLMN via the satellite NG-RAN/satellite E-UTRAN/any 3GPP or Non-3GPP Satellite access technology, which has the entry in the list of “PLMN not allowed to operate at the present UE location” present or stored in the UE (100) or the MS, and it gets emergency services from the PLMN via the satellite NG-RAN/satellite E-UTRAN/any 3GPP or Non-3GPP Satellite access technology, the UE (100) or the MS shall not delete or remove the PLMN entry along with current geographical location and the UE implementation specific distance value from the list if the registration is successful for emergency services or emergency bearer services or emergency registration is successful.

When the first PLMN & the third PLMN are in list of “PLMNs not allowed to operate at the present UE location” as the UE (100) received integrity protected reject message with 5GMM/EMM cause value #78 on the first PLMN and the third PLMN previously and includes:

At step 1 and step 2, the UE (100) initiates the registration/Attach procedure with the registration/Attach type as emergency registration (for ex-using 5GS registration type value as emergency registration or EPS attach type value as EPS emergency attach or 5GS registration result IE value set to “Registered for emergency services” or via any AS/NAS signalling message or indication) on the first PLMN via satellite NG-RAN/satellite E-UTRAN/any 3GPP or Non-3GPP Satellite access technology, for emergency services for instance an emergency call.

At step 3, the NW or the AMF or MME sends the RA (Registration accept) or Attach Accept message to the UE (100) on the first PLMN after successful the emergency registration for emergency services or emergency bearer service (for ex-using 5GS registration type value as emergency registration or EPS attach type value as EPS emergency attach or 5GS registration result IE value set to “Registered for emergency services” or via any AS/NAS signalling message or indication).

Further, the method includes as Emergency Registration is successful on the first PLMN, it shall not be removed/deleted from the list of “PLMNs not allowed to operate at the present UE location”. Further, the method includes removing PLMN from the list when:
a) the UE (100) successfully registers via the satellite NG-RAN access technology to the PLMN stored in the entry via the normal registration i.e., not by emergency registration; or
b) the timer associated with the entry of the PLMN has expired.

In an alternate embodiment, the UE (100) may delete the PLMN entry, if the current location of the UE (100) is known, the geographical location (for e.g. co-ordinates on earth) entry is stored for the entry of the PLMN, and the distance to the current UE location is larger than a UE implementation specific value.

In an embodiment, the method includes Each entry in the list of “PLMN not allowed to operate at the present UE location” shall be removed if for the entry:
a) the UE successfully registers via the satellite E-UTRAN access technology to the PLMN stored in the entry except when the UE is attached for emergency bearer services; or
b) the timer instance associated with the entry expires.

In an embodiment, the method includes Each entry in the list of “PLMN not allowed to operate at the present UE location” shall be removed if for the entry:
a) the UE successfully registers via the satellite NG-RAN access technology to the PLMN stored in the entry except when the UE registers for the emergency services; or
b) the timer instance associated with the entry expires.

FIG. 8 shows various hardware components of the UE (100), according to the embodiments as disclosed herein. In an embodiment, the UE (100) includes a processor (110), a communicator (120), a memory (130), a PLMN selection controller (140) and a PLMN list controller (150). The processor (110) is coupled with the communicator (120), the memory (130), the PLMN selection controller (140) and the PLMN list controller (150).

The PLMN list controller (150) determines whether the UE (100) is successfully registered to the PLMN stored in the list of “PLMN not allowed to operate at the present UE location” via satellite access network (500) for emergency services or normal services upon the UE (100) sends the registration request/Attach Request message to the satellite access apparatus (400) in a satellite access network (500). In an embodiment, the PLMN list controller (150) does not remove the entry from the list of “PLMN not allowed to operate at the present UE location” stored at the UE (100) upon determining that the UE (100) is successfully registered for emergency services to the PLMN stored in that entry in the list of “PLMN not allowed to operate at the present UE location” via satellite access network (500).

In other words, the PLMN list controller (150) doesn't remove or doesn't delete at least one of an entry of the PLMN, a current geographical location, and a UE implementation specific distance value from the list of “PLMN not allowed to operate at the present UE location” when the UE registration is successful for the emergency service or emergency bearer services (i.e., not for normal service) for that PLMN via satellite access network (500).

In an embodiment, the PLMN list controller (150) removes an entry from the list of “PLMN not allowed to operate at a present UE location” stored at the UE (100) upon determining that the UE (100) is successfully registered for normal services to the PLMN stored in that entry in the list of “PLMN not allowed to operate at the present UE location” via satellite access network (500). In other words, the PLMN list controller (150) removes/deletes at least one of the entry of the PLMN, the current geographical location, and the UE implementation specific distance value from the list of “PLMN not allowed to operate at the present UE location” when the UE registration is successful for the normal service (i.e., not for emergency service) for that PLMN via satellite access network (500).

The PLMN selection controller (140) determines that the UE (100) is available in the overlapping area of the first RAN and the second RAN, where the first RAN is a Home-RAN (H-RAN) (200a) and the second RAN is a Visited-RAN (V-RAN) (200b) or a shared RAN (300). Further, the PLMN selection controller (140) receives the indication from one of a NAS message and an AS message. At least one of the NAS message and the AS message is broadcasted from at least one of the first RAN and the second RAN. Further, the PLMN selection controller (140) determines the received indication indicating a selected PLMN present in the first RAN and in the second RAN. Further, the PLMN selection controller (140) prioritizes the first RAN over the second RAN for the selected PLMN. The selected PLMN includes at least one of a HPLMN, an EHPLMN and a higher priority PLMN or any allowable PLMN or any random PLMN.

The PLMN selection controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The PLMN list controller (150) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 8 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

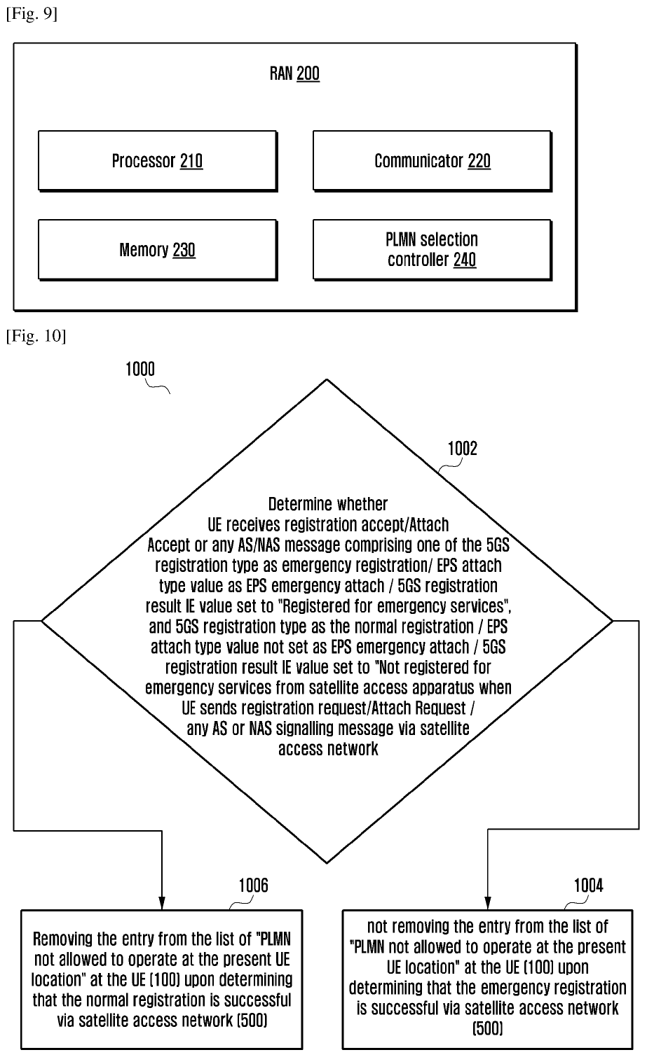

FIG. 9 shows various hardware components of the RAN (200), according to the embodiments as disclosed herein. In an embodiment, the RAN (200) includes a processor (210), a communicator (220), a memory (230) and a PLMN selection controller (240). The processor (210) is coupled with the communicator (220), the memory (230) and the PLMN selection controller (240).

The PLMN selection controller (240) broadcasts at least one of the NAS message and the AS message for the PLMN to the UE (100). Further, the PLMN selection controller (240) indicates or broadcasts a message to the UE to prioritize the first RAN over the second RAN for the selected PLMN based on at least one of the broadcasted NAS message and the broadcasted AS message.

The PLMN selection controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 9 shows various hardware components of the RAN (200) but it is to be understood that other embodiments are not limited thereon. In other embodiments, the RAN (200) may include less or more number of components. Further, the labels or names of the components are used only for illustrative purpose and does not limit the scope of the invention. One or more components can be combined together to perform same or substantially similar function in the RAN (200).

FIG. 10 is a flow chart (1000) illustrating a method, implemented by the UE (100), for handling the PLMN list, according to the embodiments as disclosed herein. The operations (1002-1006) are handled by the PLMN list controller (150).

At step 1002, the method includes determining whether the UE (100) receives the registration accept/Attach Accept or any AS/NAS message comprising one of the 5GS registration type as the emergency registration/EPS attach type value as EPS emergency attach/5GS registration result IE value set to “Registered for emergency services”, and the 5GS registration type as the normal registration (i.e. 5GS registration type not set as emergency registration)/EPS attach type value not set as EPS emergency attach/5GS registration result IE value set to “Not registered for emergency services from a satellite access apparatus (400) when the UE (100) sends the registration request/Attach Request/any AS or NAS signalling message via the satellite access network (500). At step 1004, the method includes not removing the entry from the list of “PLMN not allowed to operate at the present UE location” at the UE (100) upon determining that the emergency registration is successful via satellite access network (500). At step 1006, the method includes removing the entry from the list of “PLMN not allowed to operate at the present UE location” at the UE (100) upon determining that the normal registration is successful via satellite access network (500).

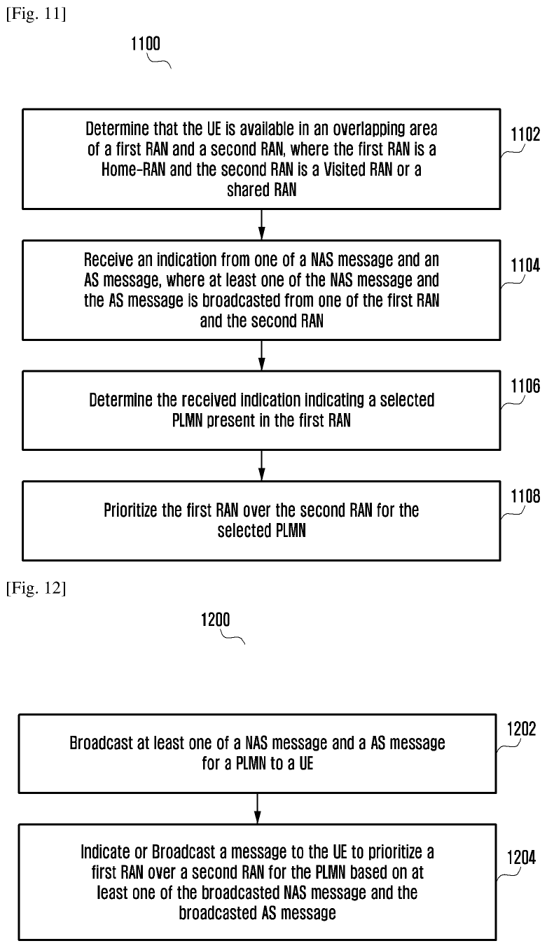

FIG. 11 is a flow chart (1100) illustrating a method, implemented by the UE (100), for handling the PLMN in the shared RAN (300), according to the embodiments as disclosed herein. The operations (1102-1108) are handled by the PLMN selection controller (140).

At 1102, the method includes determining that the UE (100) is available in the overlapping area of the first RAN and the second RAN, where the first RAN is a Home-RAN (H-RAN) (200a) and the second RAN is a Visited-RAN (V-RAN) (200b) or the shared RAN (300). At 1104, the method includes receiving the indication from one of the NAS message and the AS message, where at least one of the NAS message and the AS message is broadcasted from one of the first RAN and the second RAN. At 1106, the method includes determining the received indication indicating the selected PLMN present in the first RAN. At 1108, the method includes prioritizing the first RAN over the second RAN for the selected PLMN.

FIG. 12 is a flow chart (1200) illustrating a method, implemented by the RAN (200a), for handling the PLMN in the shared RAN (300), according to the embodiments as disclosed herein. The operations (1202-1204) are handled by the PLMN selection controller (240).

At step 1202, the method includes broadcasting at least one of the NAS message and the AS message for the PLMN to the UE (100). At step 1204, the method includes indicating or broadcasting the message to the UE to prioritize the first RAN over the second RAN for the PLMN based on at least one of the broadcasted NAS message and the broadcasted AS message.

The various actions, acts, blocks, steps, or the like in the flow charts (1000-1200) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method for handling a Public Land Mobile Network (PLMN) list in a satellite access network (500), comprises:
storing, by a User Equipment (UE) (100), a list of “PLMN not allowed to operate at a present UE location”; and
determining, by the UE (100), whether the UE (100) is successfully registered to a satellite access apparatus (400) of a PLMN stored in the list of “PLMN not allowed to operate at the present UE location” via a satellite access network (500) for an emergency service or a normal service; and
performing, by the UE (100), one of
not removing an entry from the list of “PLMN not allowed to operate at the present UE location” stored at the UE (100) upon determining that the UE (100) is successfully registered for the emergency service to the PLMN stored in that the entry in the list of “PLMN not allowed to operate at the present UE location” via the satellite access network (500), and
removing the entry from the list of “PLMN not allowed to operate at the present UE location” stored at the UE (100) upon determining that the UE (100) is successfully registered for the normal service to the PLMN stored in that entry in the list of “PLMN not allowed to operate at the present UE location” via the satellite access network (500).

2. The method as claimed in claim 1, wherein the satellite access network (500) is at least one of a satellite new generation radio access network (NG-RAN) access technology, a satellite Evolved Universal Mobile Telecommunications System (UMTS) Terrestrial Radio Access Network (E-UTRAN) access technology, a Public Land Mobile Network (PLMN) and a Radio Access Technology (RAT).

3. The method as claimed in claim 1, wherein the satellite access apparatus (400) is at least one of a Access and Mobility Management Function (AMF) and a Mobility Management Entity (MME).

4. The method as claimed in claim 1, where in each entry in the list of “PLMN not allowed to operate at the present UE location” consists of:
PLMN identity of the PLMN which sent a message including a Fifth Generation Mobility Management (5GMM) or a Evolved Universal Mobile Telecommunications System (UMTS) Terrestrial Radio Access Mobility Management (EMM) cause value #78 “PLMN not allowed to operate at the present UE location” via the satellite access network (500);
geographical location, if known by the UE (100), where the 5GMM or the EMM cause value #78 is received over the satellite access network (500); and
in case that a geographical location exists, a UE implementation specific distance value.

5. The method as claimed in claim 1, wherein determining, by the UE (100), that the UE (100) is successfully registered to the PLMN stored in the list of “PLMN not allowed to operate at the present UE location” via the satellite access network (500) for the emergency service comprises at least one of:
registering or attaching, by the UE (100), successfully to the PLMN stored in the list of “PLMN not allowed to operate at the present UE location” via the satellite access network (500) with at least one of a Fifth Generation System (5GS) Registration type value set to “emergency registration” or a Evolved Packet Subsystem (EPS) Attach type value set to “EPS Emergency Attach” or a Fifth Generation System (5GS) Registration result information element value set to “Registered for emergency services” in an AS signaling message or a NAS signaling message or receiving an indication from the satellite access apparatus (400) in the satellite access network (500) that the UE (100) is successfully registered for the emergency service or an emergency bearer service.

6. The method as claimed in claim 1, wherein determining, by the UE (100), that the UE (100) is successfully registered to the PLMN stored in the list of “PLMN not allowed to operate at the present UE location” via the satellite access network (500) for the normal services comprises at least one of:
registering or attaching, by the UE (100), successfully to the PLMN stored in the list of “PLMN not allowed to operate at the present UE location” via the satellite access network (500) with at least one of a Fifth Generation System (5GS) Registration type value not set to “emergency registration” or a Evolved Packet Subsystem (EPS) Attach type value not set to “EPS Emergency Attach” or a Fifth Generation System (5GS) Registration result information element value not set to “Registered for emergency services” in an AS signaling message or a NAS signaling message or receiving an indication from the satellite access apparatus (400) in the satellite access network (500) that the UE (100) is successfully registered for the normal service or not for an emergency bearer service or not for the emergency service.

7. The method as claimed in claim 1, wherein removing the entry from the list of “PLMN not allowed to operate at the present UE location” stored at the UE (100) comprises:
removing at least one of the entry of the PLMN, a current geographical location, and a UE implementation specific distance value from the list of “PLMN not allowed to operate at the present UE location” when the UE (100) is successfully registered for the normal service to the PLMN stored in that entry in the list of “PLMN not allowed to operate at the present UE location” via the satellite access network (500).

8. The method as claimed in claim 1, wherein not removing the entry from the list of “PLMN not allowed to operate at the present UE location” at the UE (100) comprises:
storing or keeping or maintaining or not removing at least one of an entry of the PLMN, a current geographical location; and a UE implementation specific distance value from the list of “PLMN not allowed to operate at the present UE location” when the UE (100) is successfully registered for the emergency service to the PLMN stored in that entry in the list of “PLMN not allowed to operate at the present UE location” via the satellite access network (500).

9. A User Equipment (UE) (100), comprising:
a processor (110);
a memory (130); and
a PLMN list controller (150), coupled with the processor (110) and the memory (130), configured to:
determine whether the UE (100) is successfully registered to a satellite access apparatus (400) of the PLMN stored in a list of “PLMN not allowed to operate at a present UE location” via a satellite access network (500) for an emergency service or a normal service; and
perform one of
not remove an entry from the list of “PLMN not allowed to operate at the present UE location” stored at the UE (100) upon determining that the UE (100) is successfully registered for the emergency service to the PLMN stored in that entry in the list of “PLMN not allowed to operate at the present UE location” via the satellite access network (500), and remove an entry from the list of “PLMNs not allowed to operate at the present UE location” at the UE (100) upon determining that the UE (100) is successfully registered for the normal service to the PLMN stored in that entry in the list of “PLMN not allowed to operate at the present UE location” via the satellite access network (500).

10. The UE as claimed in claim 9, wherein the satellite access network (500) is at least one of a satellite new generation radio access network (NG-RAN) access technology, a satellite Evolved Universal Mobile Telecommunications System (UMTS) Terrestrial Radio Access Network (E-UTRAN) access technology, a Public Land Mobile Network (PLMN) and a Radio Access Technology (RAT).

11. The UE as claimed in claim 9, wherein the satellite access apparatus (400) is at least one of a Access and Mobility Management Function (AMF) and a Mobility Management Entity (MME).

12. The UE as claimed in claim 9, where in each entry in the list of “PLMN not allowed to operate at the present UE location” consists of:
PLMN identity of the PLMN which sent a message including a Fifth Generation Mobility Management (5GMM) or a Evolved Universal Mobile Telecommunications System (UMTS) Terrestrial Radio Access Mobility Management (EMM) cause value #78 “PLMN not allowed to operate at the present UE location” via the satellite access network (500);
geographical location, if known by the UE (100), where the 5GMM or the EMM cause value #78 is received over the satellite access network (500); and
in case that a geographical location exists, a UE implementation specific distance value.

13. The UE as claimed in claim 9, wherein the PLMN list controller (150) further configured to:
Determine that the UE (100) is successfully registered to the PLMN stored in the list of “PLMN not allowed to operate at the present UE location” via the satellite access network (500) for the emergency service comprises at least one of:
register or attach, successfully to the PLMN stored in the list of “PLMN not allowed to operate at the present UE location” via the satellite access network (500) with at least one of a Fifth Generation System (5GS) Registration type value set to “emergency registration” or a Evolved Packet Subsystem (EPS) Attach type value set to “EPS Emergency Attach” or a Fifth Generation System (5GS) Registration result information element value set to “Registered for emergency services” in an AS signaling message or a NAS signaling message or receiving an indication from the satellite access apparatus (400) in the satellite access network (500) that the UE (100) is successfully registered for the emergency service or an emergency bearer service.

14. The UE as claimed in claim 9, wherein the PLMN list controller (150) further configured to:
Determine that the UE (100) is successfully registered to the PLMN stored in the list of “PLMN not allowed to operate at the present UE location” via the satellite access network (500) for the normal services comprises at least one of:
register or attach successfully to the PLMN stored in the list of “PLMN not allowed to operate at the present UE location” via the satellite access network (500) with at least one of a Fifth Generation System (5GS) Registration type value not set to “emergency registration” or a Evolved Packet Subsystem (EPS) Attach type value not set to “EPS Emergency Attach” or a Fifth Generation System (5GS) Registration result information element value not set to “Registered for emergency services” in an AS signaling message or a NAS signaling message or receiving an indication from the satellite access apparatus (400) in the satellite access network (500) that the UE (100) is successfully registered for the normal service or not for an emergency bearer service or not for the emergency service.

15. The UE as claimed in claim 9, wherein to remove the entry from the list of “PLMN not allowed to operate at the present UE location” stored at the UE (100), the PLMN list controller (150) further configured to:
remove at least one of the entry of the PLMN, a current geographical location, and a UE implementation specific distance value from the list of “PLMN not allowed to operate at the present UE location” when the UE (100) is successfully registered for the normal service to the PLMN stored in that entry in the list of “PLMN not allowed to operate at the present UE location” via the satellite access network (500).
